(19) United States
(12) Patent Application Publication
(10) Pub. No.: US 2015/0328760 A1
(43) Pub. Date: Nov. 19, 2015

(54) IMPACT TOOL

(71) Applicant: MAKITA CORPORATION, Anjo-shi (JP)

(72) Inventors: Hiroki IKUTA, Anjo-shi (JP); Yoshitaka MACHIDA, Anjo-shi (JP)

(21) Appl. No.: 14/714,936

(22) Filed: May 18, 2015

(30) Foreign Application Priority Data
May 16, 2014 (JP) 2014-102792

(51) Int. Cl. B25D 17/24; B25D 17/04; B25D 11/00

(52) U.S. Cl. CPC B25D 17/24; B25D 11/00; B25D 17/043

(57) ABSTRACT

A hammer drill (100) comprises a main housing (101), a hand grip (109) connected to the main housing (101) via a compression coil spring (171). In the hammer drill (100), a hammer bit (119) is driven by a motion converting mechanism (120), a hammering mechanism (140) and a rotation transmitting mechanism (150), and thereby performs a hammer-drill operation. During the hammer-drill operation, the hand grip (109) is moved against the main housing (101) in a state that biasing force of the compression coil spring (171) is applied. Further, the hammer drill (100) comprises a counterweight (190). The gravity center of the counterweight (190) is set to be lower than the upper edge of a cylinder (129) which is one component of the motion converting mechanism (120).

### CROSS REFERENCE TO RELATED APPLICATION

The present application claims priority from Japanese Patent Applications No. 2014-102792 filed on May 16, 2014, the entire contents of which are incorporated by reference herein.

### FIELD OF THE INVENTION

The present invention relates to an impact tool which performs a predetermined operation.

### BACKGROUND OF THE INVENTION

Japanese non-examined laid-open Patent Publication No. 2010-052115 discloses an impact tool which drives a tool bit linearly in its longitudinal direction by a swing member. The impact tool has a dynamic vibration reducer for reducing vibration generated during an operation.

### SUMMARY OF THE INVENTION

In the impact tool described above, since a user holds a handle and operates the impact tool during the operation, vibration generated during the operation is transmitted to the user. In this respect, less vibration transmission to the user is preferable for ensuring usability. Thus, regarding vibration reducing technique of the impact tool, further improvement is desired.

Accordingly, an object of the present disclosure is, in consideration of the above described problem, to provide an improved vibration reduction technique for an impact tool.

Above-mentioned problem is solved by the present invention. According to a preferable aspect of the present disclosure, an impact tool which drives an elongate tool bit in a longitudinal direction of the tool bit and performs a predetermined operation is provided. The impact tool comprises a motor which includes a motor shaft, a driving mechanism which is driven by the motor and drives the tool bit, and a main housing which houses the driving mechanism. The main housing may house not only the driving but also the motor. The driving mechanism comprises a motion converting mechanism which converts rotation of the motor shaft into a linear motion in the longitudinal direction of the tool bit, and a hammering mechanism which includes a bottomed cylinder member, a driving element slidably housed within the cylinder member and a hammering element driven by the driving element and hammering the tool bit. The cylinder member is configured to be driven linearly by the motion converting mechanism and arranged coaxially with the tool bit.

Further, the impact tool comprises a handle which includes a grip portion extending in a cross direction crossing the longitudinal direction of the tool bit, the handle being configured to be moved with respect to the main housing, and a biasing member which is arranged between the main housing and the handle and applies biasing force on the handle. The handle is configured to prevent vibration transmission from the main housing to the handle during the operation by relatively moving with respect to the main housing in a state that the biasing force of the biasing member is applied on the handle. That is, the handle is formed as a vibration proof handle which prevents vibration transmission from the main housing by utilizing elastic deformation of the biasing member.

Further, the impact tool comprises a weight which is housed in the main housing and movable with respect to the main housing. The weight may be mounted to the main housing directly or via an intermediate member supported by the main housing. The weight is configured to reduce vibration generated on the main housing during the operation by relatively moving with respect to the main housing.

The grip portion includes a proximal end part which is close to an axial line of the tool bit in the crossing direction and a distal end part which is remote from the axial line of the tool bit in the crossing direction. The weight is arranged such that the gravity center of the weight is positioned on a distal end part side with respect to an edge of the cylinder member which is most distant from the distal end part of the grip portion in the crossing direction. As the grip portion extends in a vertical direction, in other words the crossing direction mates with the vertical direction, the proximal end part is defined as an upper end part of the grip portion and the distal end part is defined as a lower end part of the grip portion. In such an arrangement, the edge of the cylinder member which is most distant from the distal end part is defined as an upper edge of the cylinder member. Typically, the gravity center of the weight is positioned between the edge of the cylinder member and the distal end part of the grip portion in the crossing direction.

Generally, in a relatively large impact tool which performs an operation against the ground by putting the tool bit downward, an axial line of the tool bit mates with a vertical direction during the operation. Therefore, to provide a handle which is held by a user symmetrically with respect to the axial line of the tool bit is reasonable. On the other hand, in a relatively small hand-held impact tool which performs an operation against a wall or a ceiling by supporting a tool body of the impact tool, to hold the impact tool stably during the operation is necessary. For such a reason, the handle is provided asymmetrically with respect to the axial line of the tool bit. That is, the distance between one end of the handle and the axial line of the tool bit in a handle extending direction crossing a longitudinal direction of the tool bit is different from the distance between another end of the handle and the axial line of the tool bit. In such a hand-held impact tool, the gravity center position gives a large effect on a usability of the impact tool. Taking the effect of the gravity center position into consideration, the gravity center of the weight is provided on the distal end part side with respect to the edge of the cylinder member.

According to this aspect, the weight reduces vibration generated on the main housing during the operation, and the handle prevents vibration from transmitting from the main housing to the handle. That is, the impact tool has two types of vibration proof mechanisms. Thus, to reduce vibration on the grip portion held by a user during the operation is achieved. As a result, usability and operability of the impact tool for a user is improved.

According to a further preferable aspect of the present disclosure, the weight is configured to be driven and forcibly moved against the main housing by the motor. Typically, the weight is reciprocated linearly along the longitudinal direction of tool bit.

According to a further preferable aspect of the present disclosure, the motion converting mechanism comprises a swing member which converts rotation of the motor shaft into a linear motion, and the weight is connected to the swing member. Accordingly, the weight is reciprocated linearly by the linear motion converted by the swing member. That is, the swing member has not only a function of driving the tool bit but also a function of driving the weight.

According to a further preferable aspect of the present disclosure, the swing member is configured to swing in the longitudinal direction of the tool bit on a plane which includes the axial line of the tool bit and an axial line of the grip portion. That is, the plane is formed as a virtual vertical plane which passes the center of the impact tool. The weight comprises a first weight part disposed one side of the swing member with respect to the plane and a second weight part disposed another side of the swing member with respect to the plane. That is, the plane is located between the first weight part and the second weight part. In other words, the first weight part and the second weight part are arranged right side and left side of the impact tool with respect to the vertical plane. Accordingly, the weight is arranged in good balance with respect to the swing member.

According to a further preferable aspect of the present disclosure, the impact tool comprises a support part which supports the weight. The weight is driven by the swing member and causes a pendulum motion around the support part as a fulcrum. That is, by providing the support part, the weight is driven by the swing member. Accordingly, the weight is driven by a simple mechanism.

According to a further preferable aspect of the present disclosure, the impact tool comprises an elastic member which elastically biases the weight. The weight and the elastic member serve as a dynamic vibration reducer. In the dynamic vibration reducer, the weight is relatively moved against the main housing in a state that the elastic member biases the weight.

According to a further preferable aspect of the present disclosure, the impact tool comprises an outer housing which covers at least a part of a region of the main housing which covers the driving mechanism and the motor. Further, the handle is connected to the outer housing and integrally moved with the outer housing with respect to the main housing. The biasing member is arranged interveningly between the outer housing and the main housing, and thereby the outer housing is provided as a vibration proof handle. Accordingly, vibration transmission during the operation from the main housing to the outer housing is prevented. That is, vibration transmission to the handle is prevented.

According to a further preferable aspect of the present disclosure, the impact tool comprises an auxiliary handle attachable part to which an auxiliary handle is detachably attached. The auxiliary handle attachable part is connected to the outer housing and integrally moved with the handle connected to the outer housing with respect to the main housing. That is, the outer housing has not only a function of a vibration proof housing but also a function of connecting the handle and the auxiliary handle attachable part. Accordingly, the auxiliary handle attached to the auxiliary handle attachable part is moved integrally with the handle against the main housing. As a result, when a user holds the auxiliary handle and the handle respectively and performs the operation, usability of the impact tool for a user is improved.

According to a further preferable aspect of the present disclosure, the impact tool comprises a controller which controls rotation speed of the motor to be driven at substantially constant rotation speed. The substantially constant rotation speed means rotation speed within a predetermined range. That is, the controller controls the motor at a predetermined rotation speed within a predetermined range even though rotation speed of the motor may be fluctuated due to load applied on the motor during the operation. In other words, the motor is controlled at substantially constant rotation speed state by the controller. Accordingly, the motor keeps the predetermined rotation speed in spite of load applied on the motor during the operation. As a result, working efficiency of the impact tool is prevented from fluctuating. Specifically, in a case that the motor serves as a brushless motor, a controller for driving the brushless motor is necessary. Thus, by utilizing the controller for driving the brushless motor, the motor is driven in substantially constant rotation speed.

According to a further preferable aspect of the present disclosure, the motor is arranged such that the motor shaft is parallel to the axial line of the tool bit. In the impact tool in which the motor shaft is parallel to the axial line of the tool bit, to utilize the swing member for driving the tool bit is reasonable.

According to a further preferable aspect of the present disclosure, the grip portion is disposed on an extending line of the axial line of the tool bit. In this aspect, at least a part of the grip portion is disposed on the extending line of the axial line of the tool bit. As the grip portion held (gripped) by a user is on the extending line of the axial line of the tool bit, power of a user holding the grip portion is reasonably transmitted to the tool bit. Accordingly, a hammering operation on a workpiece is effectively performed.

According to a further preferable aspect of the present disclosure, a battery mounting part to which a battery is detachably mounted is formed on the distal end part of the grip portion. The cylinder member is arranged at the proximal end part side and the battery mounted to the battery mounting part is arranged at the distal end part side. Accordingly, the impact tool is in a good balance with respect to the grip portion held by a user. As a result, usability of the impact tool for a user holding the grip portion is improved.

According to a further preferable aspect of the present disclosure, a dust collecting device mounting part to which a dust collecting device for collecting dust during the operation is detachably mounted. The dust collecting device mounting part may be formed on the handle or on the main housing.

Accordingly, an improved vibration reduction technique for an impact tool is provided.

Other objects, features and advantages of the present disclosure will be readily understood after reading the following detailed description together with the accompanying drawings and the claims.

### BRIEF DESCRIPTION OF THE DRAWINGS

FIG. 1 shows a cross sectional view of a hammer drill according to a first embodiment of the present disclosure.

FIG. 2 shows a front view of a counterweight shown along an arrow R in FIG. 1.

FIG. 3 shows a front view of another variation of the counterweight.

FIG. 4 shows a cross sectional view of a hammer drill according to a second embodiment of the present disclosure.

FIG. 5 shows a side view of a hammer drill according to a third embodiment of the present disclosure.

FIG. 6 shows a cross sectional view of the hammer drill shown in FIG. 5.

FIG. 7 shows an exploded side view of the hammer drill shown in FIG. 5.

FIG. 8 shows a cross sectional view taken along the VIII-VIII line in FIG. 6.

FIG. 9 shows a cross sectional view taken along the IX-IX line in FIG. 6.

FIG. 10 shows a side view of the hammer drill in which a hand grip is positioned forward.

FIG. 11 shows a partial cross sectional view of a hammer drill according to a fourth embodiment of the present disclosure.

FIG. 12 shows a cross sectional view taken along the XII-XII line in FIG. 11.

FIG. 13 shows a cross sectional view of a dynamic vibration reducer taken along the XIII-XIII line in FIG. 12.

FIG. 14 shows a cross sectional view of the dynamic vibration reducer in which a weight is positioned forward.

FIG. 15 shows a cross sectional view of the dynamic vibration reducer in which the weight is positioned rearward.

### DESCRIPTION OF THE PREFERRED EMBODIMENTS

Each of the additional features and method steps disclosed above and below may be utilized separately or in conjunction with other features and method steps to provide and manufacture improved impact tools and method for using such impact tools and devices utilized therein. Representative examples of the invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

### First Embodiment

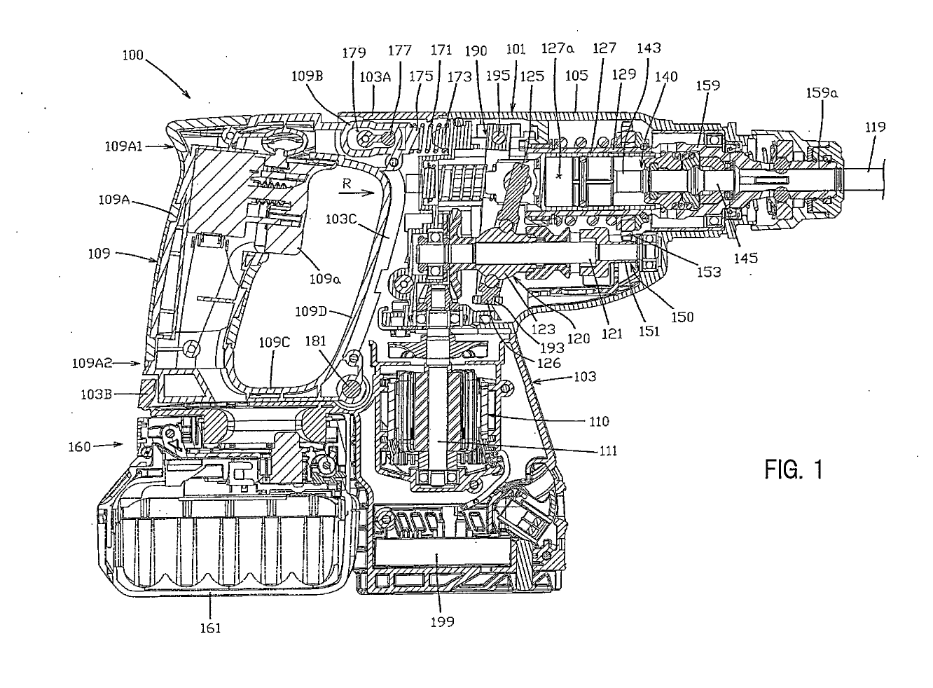

A first embodiment of the present disclosure is explained with reference to FIG. 1 to FIG. 5. In the first embodiment, an electrical hammer drill is utilized to explain as one example of an impact tool. As shown in FIG. 1, a hammer drill 100 is an impact tool which has a hammer bit 119 attached to a front end region of a main housing 101 and performs chipping, drilling or other similar operation on a workpiece (e.g. concrete) by driving the hammer bit 119 to perform a striking movement in its axial direction and a rotational movement around its axis. The hammer bit 119 is one example which corresponds to “a tool bit” of this disclosure.

The hammer drill 100 mainly includes the main housing body 101 that forms an outer shell of the hammer drill 100. The hammer bit 119 is detachably coupled to the front end region of the main housing 101 via a cylindrical tool holder 159. The hammer bit 119 is inserted into a bit insertion hole 159a of the tool holder 159 and held such that it is allowed to reciprocate in its axial direction (longitudinal direction) with respect to the tool holder 159 and prevented from rotating in its circumferential direction with respect to the tool holder 159. The axial line of the hammer bit 119 is in conformity with an axis of the tool holder 159.

The main housing 101 mainly includes a motor housing 103 that houses an electric motor 110, and a gear housing 105 that houses a motion converting mechanism 120, a hammering mechanism 140 and a rotation transmitting mechanism 150. A hand grip 109 designed to be held by a user is connected to the main housing 101 on the side opposite to the hammer bit 119 in the axial direction of the hammer bit 119. For convenience of explanation, the hammer bit 119 side of the hammer drill 100 in the longitudinal direction of the hammer bit 119 is defined as front side, and the hand grip 109 side of the hammer drill 100 in the longitudinal direction of the hammer bit 119 is defined as rear side. The main housing 101 and the hand grip 109 are examples which correspond to “a main housing” and “a handle” of this disclosure, respectively.

The main housing 101 has the gear housing 105 in front and the motor housing 103 in the rear in the longitudinal direction of the hammer bit 119. The hand grip 109 is connected to the rear of the motor housing 103. The motor housing 103 extends downward from the underside of the gear housing 105 and houses the electric motor 110 within this extending region. The electric motor 110 is provided as a brushless motor. The electric motor 110 is disposed such that its rotation axis extends in a vertical direction and crosses an axially extending axis of striking movement of the hammer bit 119. A controller 199 which controls the driving of the electric motor 110 is disposed below the electric motor 110.

A rotating output of the electric motor 110 is appropriately converted into linear motion by the motion converting mechanism 120 and then transmitted to the hammering mechanism 140. As a result, a hammering force (impact force) is generated in the longitudinal direction of the hammer bit 119 via the hammering mechanism 140. Further, the speed of the rotating output of the electric motor 110 is appropriately reduced by the motion transmitting mechanism 150 and then the decelerated rotation is transmitted to the hammer bit 119. As a result, the hammer bit 119 is caused to rotate in a circumferential direction around the longitudinal direction. The electric motor 110 is energized by depressing a trigger 109a disposed on the hand grip 109. The motion converting mechanism 120 and the hammering mechanism 140 are examples which correspond to the “a driving mechanism” of this disclosure.

The motion converting mechanism 120 is disposed above a motor shaft 111 of the electric motor 110 and serves to convert the rotating output of the motor shaft 111 into linear motion in the longitudinal direction of the hammer bit 119. The motion converting mechanism 120 mainly includes an intermediate shaft 121 which is rotationally driven by the motor shaft 111, a rotating element 123 fitted onto the intermediate shaft 121, a swing member 125 which is caused to swing in the longitudinal direction of the hammer drill 100 by rotation of the intermediate shaft 121 (the rotating element 123), a cylindrical piston 127 which is caused to reciprocate in the longitudinal direction of the hammer drill 100 by swinging movement of the swing member 125, and a cylinder 129 which houses the piston 127. The motor shaft 111 is disposed perpendicularly to the intermediate shaft 121. The cylinder 129 is integrally formed with the tool holder 159 as a rear region of the tool holder 159. The cylinder 129 is one example which corresponds to “a cylinder member” of this disclosure.

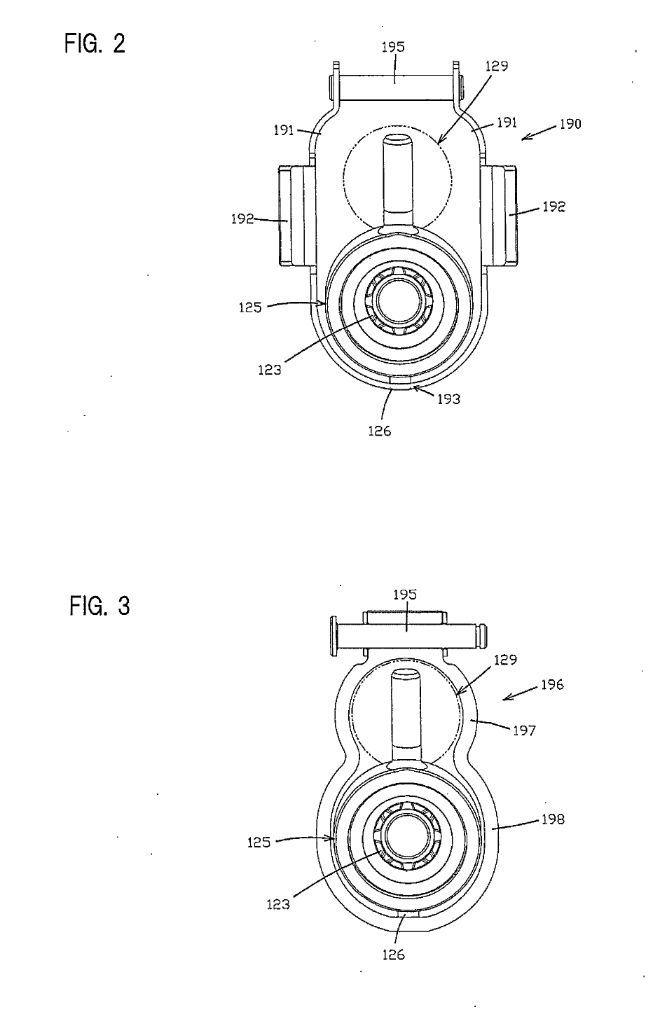

As shown in FIG. 1 and FIG. 2, a counterweight 190 is connected to the swing member 125. The counterweight 190 is rotatably supported by a support shaft 195 which extends in the lateral direction of the hammer drill 100. The support shaft 195 is fixedly connected to the gear housing 105. The counterweight 190 is one example which corresponds to “a weight” of this disclosure.

As shown in FIG. 2, the counterweight 190 is formed as substantially U-shaped member which surrounds the swing member 125. The counterweight 190 includes right and left arm parts 191, and a weight part 192. The weight part 192 is disposed on an intermediate region of the arm parts 191. The weight part 192 is arranged lower region than the upper edge of the cylinder 129 in the vertical direction of the hammer drill 100. Accordingly, the gravity center of the counterweight 190 in the vertical direction of the hammer drill 100 is positioned below the upper edge of the cylinder 129. Further, the gravity center of the two weight parts 192 in the lateral direction of the hammer drill 100 is in conformity with the center of the cylinder 129. In other words, the gravity center of the two weight parts 192 in the vertical direction of the hammer drill 100 is positioned between the right side edge and the left side edge of the cylinder 129.

As shown in FIG. 1 and FIG. 2, an engagement hole 193 which is engaged with a protrusion 126 of the swing member 125 is formed at the lower end part of the left and right arm parts 192. That is, the engagement hole 193 is disposed on the connection part of the left and right arm parts 192. When the swing member 125 swings in the front-rear direction of the hammer drill 100 (longitudinal direction of the hammer bit 119), the protrusion 126 engages with the engagement hole 193 and thereby a pendulum motion of the counterweight 190 around the support shaft 195 as a fulcrum is generated. That is, the swing member 125 drives the counterweight 190. The swing member 125 is one example which corresponds to “a swing member” of this disclosure.

The protrusion 126 is arranged at the lower end part of the swing member 125 opposite to the upper end part which is connected to the piston 127. Thus, when the piston 127, the striker 143 and the impact bolt 145 are moved forward by swinging motion of the swing member 125, the weight parts 192 of the counterweight 190 are moved rearward.

As to a shape of the counterweight 190, is it not limited to U-shape shown in FIG. 2. For example, the counterweight may be formed as a closed looped member shown in FIG. 3. The counterweight 196 shown in FIG. 3 includes a first circular arc part 197 which corresponds to an arc shape of the cylinder 129 and a second circular arc part 198 which corresponds to an arc shape of the swing member 125. That is, the first and second circular arc parts 197, 198 are connected to serve the counterweight 196. The gravity center of the counterweight 196 in the vertical direction of the hammer drill 100 is positioned below the upper edge of the cylinder 129, similar to the counterweight 190.

The hammering mechanism 140 is disposed above the motion converting mechanism 120 and rearward of the tool holder 159. The hammering mechanism 140 mainly includes a hammering element in the form of a striker 143 which is slidably disposed within the cylindrical piston 127 and an impact bolt 145 which is disposed in front of the striker 143. Further, a space formed behind the striker 143 within the piston 127 forms an air chamber 127a which serves to transmit sliding movement of the piston 127 to the striker 143 via fluctuations of air pressure. The air chamber 127a is served as an air spring. The striker 143 slides within the piston 127 and hits the impact bolt 145.

The rotation transmitting mechanism 150 is disposed forward of the motion converting mechanism 120 and serves to transmit rotation of the electric motor 110 transmitted via the intermediate shaft 121 of the motion converting mechanism 120 to the tool holder 159. The rotation transmitting mechanism 150 mainly includes a gear speed reducing mechanism having a plurality of gears such as a first gear 151 which rotates together with the intermediate shaft 121, and a second gear 153 which is engaged with the first gear 151 and fitted onto the tool holder 159 (the cylinder 129).

As shown in FIG. 1, an upper connection part 103A which extends substantially horizontally in a rearward direction from an upper rear end of the motor housing 103, a lower connection part 103B which extends substantially horizontally in a rearward direction from a lower rear end of the motor housing 103 and an intermediate wall part 103C which connects the upper connecting part 103A and the lower connecting part 103B are provided at the rear of the motor housing 103.

A battery mounting part 160 is formed on an underside of the lower connecting part 103B of the motor housing 103. That is, the battery mounting part 160 is disposed behind the motor housing 103 and below the hand grip 109. A battery pack 161 which serves to feed driving current to the electric motor 110 is detachably mounted on the battery mounting part 160 by sliding it horizontally forward from the rear. The battery mounting part 160 is one example which corresponds to “a battery mounting part” of this disclosure.

As shown in FIG. 1, the hand grip 109 has a grip portion 109A, an upper arm part 109B, a lower arm part 109C and a stay 109D. The grip portion 109A extends in vertical direction which crosses the longitudinal direction of the hammer bit 119. The grip portion 109A is partly disposed on an extending line of the axis of the hammer bit 119. An upper end of the grip portion 109A is defined as a grip portion proximal part 109A1 which is close to the axis of the hammer bit 119 in the vertical direction of the hammer drill 100. Further, a lower end of the grip portion 109A is defined as a grip portion distal part 109A2 which is remote from the axis of the hammer bit 119 in the vertical direction of the hammer drill 100. That is, the hand grip 109 is disposed asymmetrically with respect to the axis of the hammer bit 119 in the vertical direction perpendicular to the longitudinal direction of the hammer bit 119. In other words, length of the grip portion 109A above the axis of the hammer bit 119 and length of the grip portion 109A below the axis of the hammer bit 119 in the vertical direction are different to each other. The grip portion 109A is one example which corresponds to “a grip portion” of this disclosure.

The gravity center of the counterweight 190, 196 is located between the grip portion distal part 109A2 and the cylinder 129 in the vertical direction of the hammer drill 100. That is, as the grip portion proximal part 109A1 is close to the upper edge of the cylinder 129, a user normally holds substantially middle region of the grip portion 109A to which the gravity center of the counterweight 190, 196 is located.

The upper arm part 109B extends forward from an upper end of the grip portion 109A in its extending direction. The lower arm part 1090 extends forward from a lower end of the grip portion 109A in its extending direction. The stay 109D extends generally parallel to the grip portion 109A and connects front ends of the upper arm part 109B and the lower arm part 1090. With such a construction, the hand grip 109 is configured as a closed-loop one-piece frame structure.

The upper arm part 109B is connected to the gear housing 105 via a compression coil spring 171. The lower arm part 109C is rotatably connected to the motor housing 103 via a support shaft 181. The support shaft 181 extends in a lateral direction of the hammer drill 100, which crosses the longitudinal direction of the hammer bit 119. The compression coil spring 171 is one example which corresponds to “a biasing member” of this disclosure.

The compression coil spring 171 is disposed above the axis of striking movement of the hammer bit 119 such that it extends in the longitudinal direction of the hammer bit 119 within the upper connecting part 103A of the motor housing 103. Further, a front end of the compression coil spring 171 is supported by a spring receiver 173 formed on the rear of the gear housing 105 and a rear end of the compression coil spring 171 is supported by a spring receiver 175 formed on the upper arm part 109B of the handgrip 109. With such a construction, biasing force of the compression coil spring 171 biases the hand grip 109 rearward from the gear housing 105 (main housing 101).

A metal stopper pin 177 is provided in the upper connection part 103A of the motor housing 103 and serves to receive the biasing force of the compression coil spring 171 biases the hand grip 109. The stopper pin 177 extends in the lateral direction of the hammer drill 100 through a transverse hole 179 formed rearward of the compression coil spring 171 in the upper arm part 109B of the hand grip 109, and ends of the stopper pin 177 are fixed to the upper connection part 103A. The stopper pin 177 is allowed to move relatively in the longitudinal direction of the hammer bit 119 within the transverse hole 179.

The support shaft 181 is disposed in the lower connection part 103B of the motor housing 103. The support shaft 181 is made of metal and disposed such that it penetrates the hand grip 109 in the lateral direction of the hammer drill 100. Thus, in the hand grip 109, the upper arm part 109B is elastically connected to the gear housing 105 via the compression coil spring 171 and the lower arm part 109C is connected to the motor housing 103 via the support shaft 181 in a rotatable manner around the support shaft 181.

In the hammer drill 100 described above, when the trigger 109a on the hand grip 109 is pulled (manipulated), the controller 199 drives the electric motor 110. The controller 199 controls the rotation speed of the electric motor 110 within a predetermined rotation speed range. That is, in order to avoid a large change of the rotation speed of the electric motor 110 due to load during the operation, the controller 199 controls the rotation speed of the electric motor 110 within the predetermined rotation speed range. In other words, the controller 199 controls the electric motor 110 under substantially constant rotation speed state. When the electric motor 110 is rotationally driven, the hammer-drill operation as the operation is performed by the motion converting mechanism 120, the hammering mechanism 140 and the rotation transmitting mechanism 150. The controller 199 is one example which corresponds to “a controller” of this disclosure.

During the operation, vibration mainly in the longitudinal direction of the hammer bit 119 is generated on the main housing 101. By rotating the hand grip 109 around the support shaft 181, vibration transmission from the main housing 101 to the hand grip 109 is prevented by the compression coil spring 171. That is, kinetic energy of the vibration is consumed by deformation of the compression coil spring 171 and thereby vibration transmission to the hand grip 109 is prevented.

Further, during the operation, the pendulum motion of the counterweight 190, 196 is occurred by the swing motion of the swing member 125. The motion of the counterweight 190, 196 in substantially front-rear direction of the hammer drill 100 is in approximately opposite phase to the motion of the striker 143 and the impact bolt 145. That is, when the striker 143 and the impact bolt 145 are moved forward, the counterweight 190 is moved rearward, and when the striker 143 and the impact bolt 145 are moved rearward, the counterweight 190, 196 is moved forward. Accordingly, the counterweight 190, 196 reduces vibration in the front-rear direction generated on the main housing 101 during the operation.

As described above, the hammer drill 100 has a first vibration proof mechanism in the form of the vibration proof handle in which the hand grip 109 is relatively moved against the main housing 101, and a second vibration proof mechanism in the form of the counterweight 190, 196. Accordingly, vibration transmission to a user holding the grip portion 109A of the hand grip 109 is prevented. As a result, a usability of the hammer drill 100 is improved.

Further, the gravity center of the counterweight 190, 196 is located between the grip portion distal part 109A2 and the cylinder 129. That is, the gravity center of the counterweight 190, 196 is set to correspond to the intermediate region of the grip portion 109A which is mainly held by a user. Accordingly, with respect to the vertical direction of the hammer drill 100, the gravity center of the counterweight 190, 196 matches with the holding (gripping) region by a user. With such a construction, inertia force of the counterweight 190, 196 is prevented from applying on a user's hand as a moment. As a result, a usability of the hammer drill 100 is improved.

### Second Embodiment

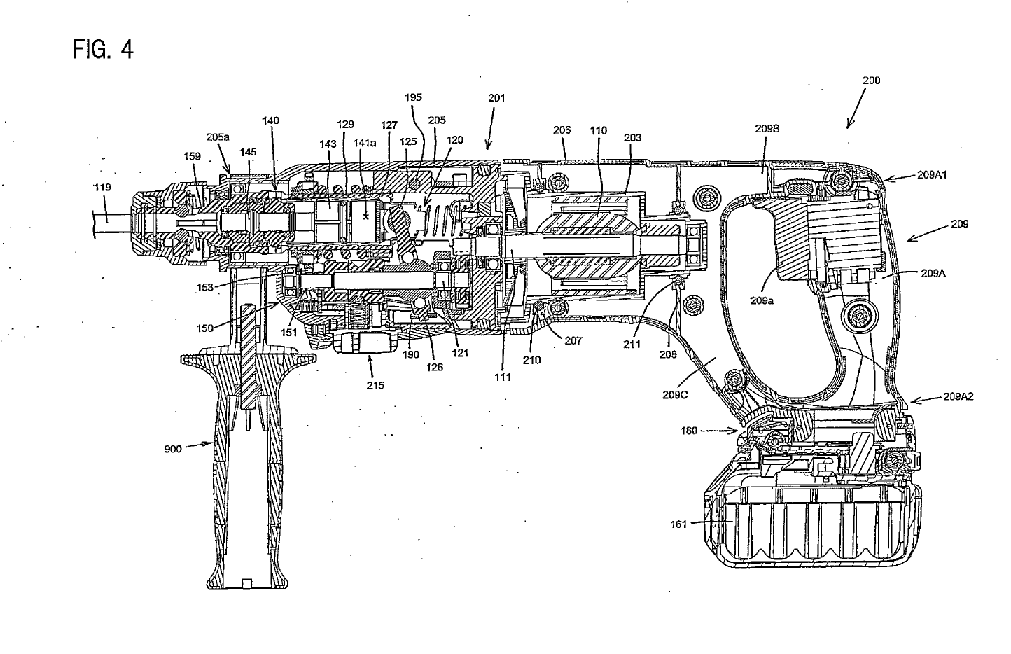

Next, a second embodiment of this disclosure is explained with reference to FIG. 4. The similar constructions that are the same as those in the first embodiment have been assigned the same reference numbers and explanation thereof is therefore omitted.

As shown in FIG. 4, in a hammer drill 200, the electric motor 110 is disposed such that the motor shaft 111 is parallel to the longitudinal direction of the hammer bit 119. A main housing 201 of the hammer drill 200 includes a motor housing 203 and a gear housing 205. The motor housing 203 houses the electric motor 110. The gear housing 205 houses the motion converting mechanism 120, the hammering mechanism 140 and the rotation transmitting mechanism 150. A side handle attachable part 205 to which a side handle 900 is detachably mounted is provided on a front region of the gear housing 205.

An outer housing 206 and a hand grip 209 are disposed opposite to the hammer bit 119 with respect to the main housing 201 in the longitudinal direction of the hammer bit 119 (longitudinal direction of the main housing 201). For convenience of explanation, the hammer bit 119 side of the hammer drill 200 in the longitudinal direction of the hammer bit 119 is defined as front side, and the hand grip 209 side of the hammer drill 200 in the longitudinal direction of the hammer bit 119 is defined as rear side. The main housing 201 and the hand grip 209 are examples which correspond to “a main housing” and “a handle” of this disclosure, respectively.

The cylindrical outer housing 206 which covers the motor housing 203 is disposed outside the motor housing 203. The hand grip 209 is integrally formed with the outer housing 206 on the rear region of the outer housing 206.

The hand grip 209 mainly includes a grip portion 209A, an upper connection part 209B, a lower connection part 209C. The grip portion 209A extends in a vertical direction of the hammer drill 200 which crosses the longitudinal direction of the hammer bit 119. The grip portion 209A is disposed partly on an extending line of the axis of the hammer bit 119. An upper end of the grip portion 209A is defined as a grip portion proximal part 209A1 which is close to the axis of the hammer bit 119 in the vertical direction of the hammer drill 200. Further, a lower end of the grip portion 209A is defined as a grip portion distal part 209A2 which is remote from the axis of the hammer bit 119. The grip portion 209A is one example which corresponds to “a grip portion” of this disclosure.

The upper connection part 209B and the lower connection part 209C connect the grip portion 209A and the outer housing 206. That is, the upper connection part 209B connects the grip portion proximal part 209A1 and an upper region of the outer housing 206. The lower connection part 209C connects the grip portion distal part 209A2 and a lower region of the outer housing 206. The upper connection part 209B extends to be parallel to the longitudinal direction of the hammer bit 119. The lower connection part 209C extends to be inclined against the longitudinal direction of the hammer bit 119. Accordingly, the outer housing 206, the upper connection part 209B, the grip portion 209A and the lower connection part 209C form a closed-loop.

A battery mounting part 160 to which a battery pack is detachably mounted is disposed on the grip portion distal part 209A2 of the grip portion 209A. A trigger 209a is disposed on the grip portion 209A.

Further, disk-shaped rubber receiving flanges 207, 208 are disposed inside the outer housing 206. Ring rubbers 210, 211 are arranged on each inner surface of the rubber receiving flanges 207, 208. The flanges 207, 208 engage with the motor housing 203 via the ring rubber 210, 211. The flange 207 and the ring rubber 210 are disposed forward of the electric motor 110, and the flange 208 and the ring rubber 211 are disposed rearward of the electric motor 110 in an axial direction of the motor shaft 111. Thus, the hand grip 209 and the outer housing 206 are relatively movable with respect to the motor housing 203 (main housing 201) in a state that elastic force of the ring rubbers 210, 211 are applied. The ring rubbers 210, 211 are examples which correspond to “a biasing member” of this disclosure.

Furthermore, similar to the first embodiment, the hammer drill 200 includes the counterweight 160 which causes a pendulum motion around the support shaft 195 as a fulcrum. The counterweight 160 is drive by the swing member 125. The counterweight may be formed as shown in FIG. 3. The gravity center of the counterweight 190, 196 is located between the grip portion distal part 209A2 and the cylinder 129 in the vertical direction of the hammer drill 200. That is, the gravity center of the counterweight 190, 196 is set to correspond to the intermediate region of the grip portion 209A which is mainly held by a user.

In the hammer drill 200 described above, when the trigger 209a is pulled, the electric motor 110 is driven. Thus, one of the operations is performed by the motion converting mechanism 120, the hammering mechanism 140 and/or the rotation transmitting mechanism 150. That is, the hammer drill 200 is configured to perform the hammering operation and the hammer-drill operation. The hammering operation is performed in a hammering mode as a driving mode in which the motion converting mechanism 120 and the hammering mechanism 140 are driven and thereby the hammer bit 119 is only linearly driven in the longitudinal direction of the hammer bit 119. The hammer-drill operation is performed in a hammer-drill mode as a driving mode in which the motion converting mechanism 120, the hammering mechanism 140 and the rotation transmitting mechanism 150 are driven and thereby the hammer bit 119 is linearly driven in and rotationally driven around the longitudinal direction of the hammer bit 119. The driving modes between the hammer mode and the hammer-drill mode are selectively switched by a user by manipulating a mode switching dial 215.

During the operation, vibration is generated on the main housing 201 mainly in the longitudinal direction of the hammer bit 119. With respect to the longitudinal vibration, the hand grip 209 is relatively moved against the main housing 201 (motor housing 203) via the ring rubbers 210, 211 and thereby vibration transmission from the main housing 201 to the hand grip 209 is prevented by the ring rubbers 210, 211. That is, the kinetic energy of the vibration is consumed by deformation of the ring rubbers 210, 211 and thereby vibration transmission to the hand grip 209 is prevented.

Furthermore, similar to the first embodiment, the counterweight 190, 196 of the hammer drill 200 reduces the mainly longitudinal vibration generated on the main housing 201. That is, the hammer drill 200 has a first vibration proof mechanism in the form of the vibration proof handle in which the hand grip 209 is relatively moved against the main housing 201, and a second vibration proof mechanism in the form of the counterweight 190, 196. Accordingly, vibration transmission to a user holding the grip portion 209A of the hand grip 209 is prevented. As a result, a usability of the hammer drill 200 is improved.

### Third Embodiment

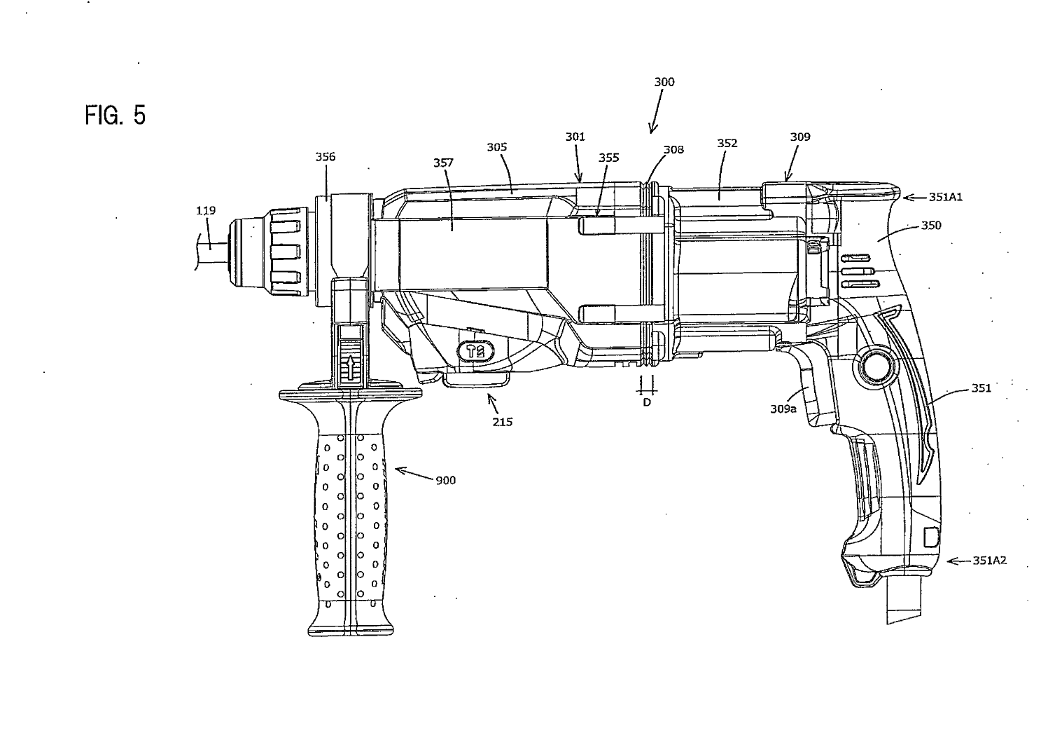

Next, a third embodiment of this disclosure is explained with reference to FIG. 5 to FIG. 10. In a hammer drill 300 of the third embodiment, constructions of a hand grip and a side handle mounting part are mainly difference from the hammer drill 200 of the second embodiment. Accordingly, similar constructions that are the same as those in the first and second embodiments have been assigned the same reference numbers and explanation thereof is therefore omitted.

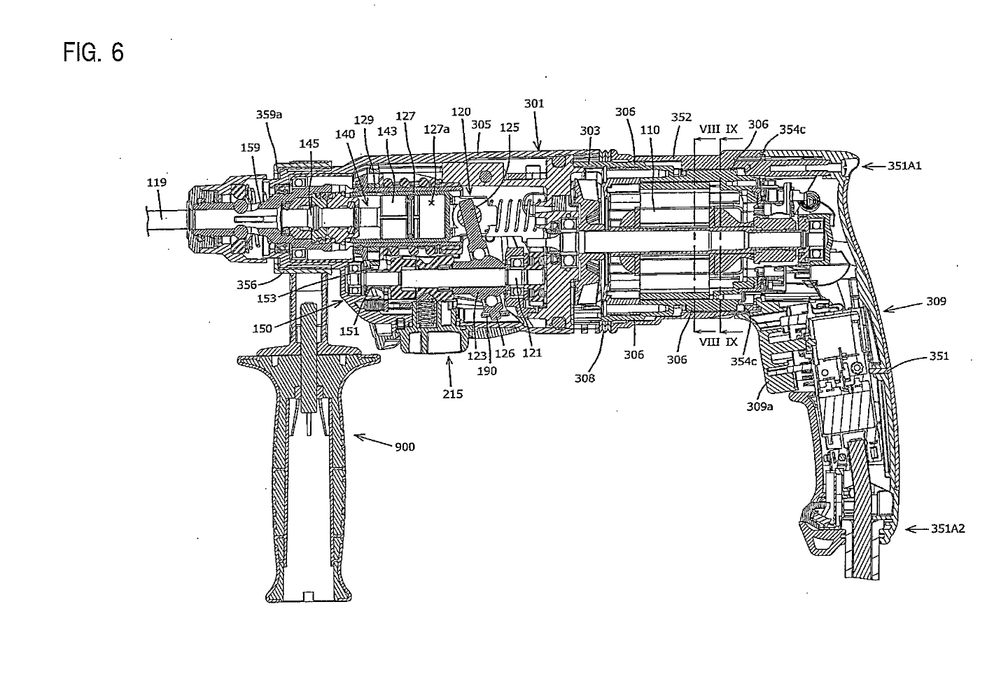

As shown in FIG. 5 and FIG. 6, a main housing 301 of the hammer drill 300 includes a motor housing 303 and a gear housing 305. As shown in FIG. 6, the motor housing 303 houses the electric motor 110. The gear housing 305 houses the motion converting mechanism 120, the hammering mechanism 140 and the rotation transmitting mechanism 150. A grip portion 351 of a hand grip 309 is disposed at a rear region of the hammer drill 300 opposite to a front region of the main housing 301. For convenience of explanation, the hammer bit 119 side of the hammer drill 300 in the longitudinal direction of the hammer bit 119 is defined as front side, and the hand grip 309 side of the hammer drill 300 in the longitudinal direction of the hammer bit 119 is defined as rear side. The main housing 301 and the hand grip 309 are examples which correspond to “a main housing” and “a handle” of this disclosure, respectively.

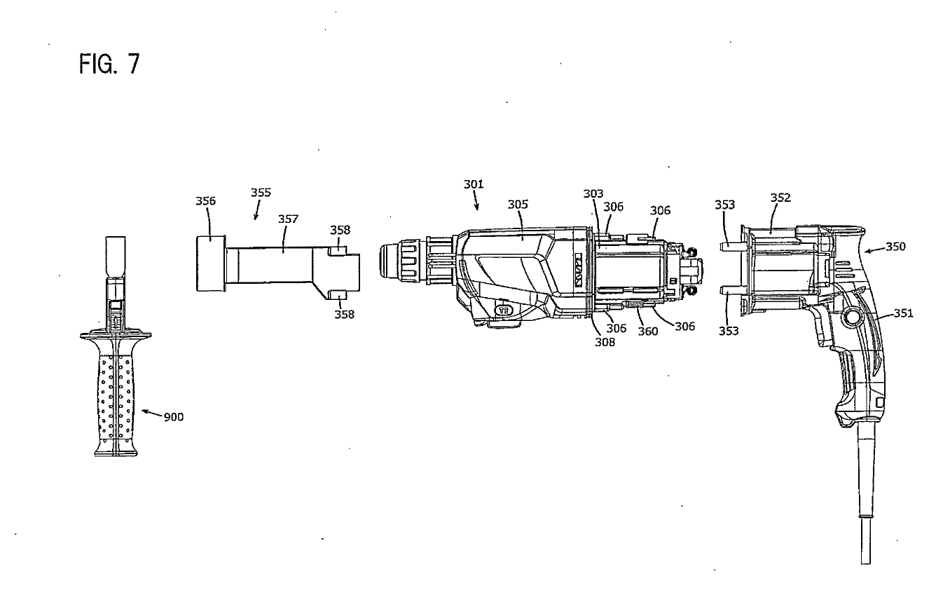

As shown in FIG. 5 and FIG. 7, the hand grip 309 serves as a main handle for holding the hammer drill 300 by a user. The hand grip 309 is made of resin and is mainly provided with a handle rear part 350 and a handle front part 355. The handle rear part 350 is mainly provided with the grip portion 351 which is held by a user, a cylindrical housing part 352 which is disposed forward of the grip portion 351. The grip portion 351 is formed such that an upper end part of the grip portion 351 in the form of a grip portion proximal part 351A1 is connected to a rear end part of the housing part 352. The grip portion 351 extends downward from the grip portion proximal part 351A1 so as to cross the longitudinal direction of the hammer bit 119. The lower end part of the grip portion 351 in the form of a grip portion distal part 351A2 is formed as a free end, and an electric cable for providing electric current is connected thereto. Further, a trigger 309a is provided on the grip portion 351. When the trigger 309a is pulled, a controller (not shown) controls and drives the electric motor 110 by providing electric current from an outer power source via the electric cable. The controller is configured, similar to the first embodiment, to control the electric motor 110 under substantially constant rotation speed state. The housing part 352 has engagement protrusions 353 which protrude forward from the housing part 352. The grip portion 351 is one example which corresponds to “a grip portion” of this disclosure.

The handle front part 355 is mainly provided with a side handle mounting part 356 to which the side handle 900 is mounted and an extending part 357 which is disposed rearward of the side handle mounting part 356. The side handle mounting part 356 is formed as a cylindrical member which surrounds the front region of the gear housing 305 (hammer bit 119 side region). The extending part 357 extends in the longitudinal direction of the hammer bit 119 and has engagement recesses 358 which engage with the engagement protrusion 353 on the rear end region of the extending part 357. The side handle mounting part 356 is one example which corresponds to “a side handle mounting part” of this disclosure.

As shown in FIG. 7, the motor housing 303 has a plurality of slide guides 306 which are disposed outside the electric motor 110 at each place different from each other in a circumference direction around the electric motor 110. The slide guides 306 are disposed at two places of a front place and a rear place in the longitudinal direction of the hammer bit 119. That is, the front slide guides 306 are disposed at a plurality places in the circumference direction of the electric motor 110, and the rear slide guides 306 are also disposed at a plurality places in the circumference direction of the electric motor 110. The slide guide 306 is made of a metallic cover which covers a protrusion made of resin on the motor housing 303. The metallic cover may be made of metallic material such as steel, aluminum, magnesium, titanium and so on. Further, a plurality of coil springs 360 are disposed on the outer surface of the motor housing 303.

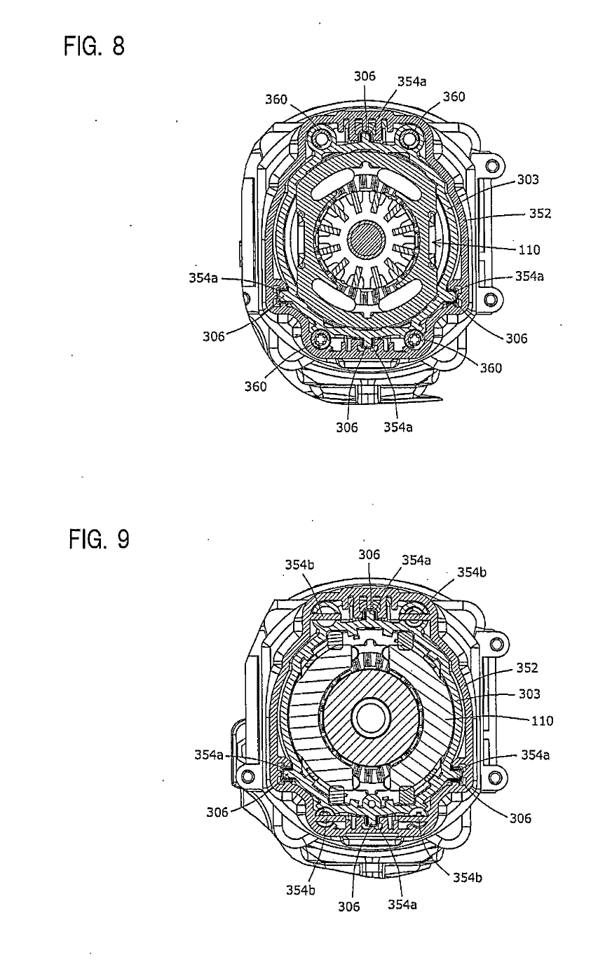

As shown in FIG. 8 and FIG. 9, a plurality of recesses 354a, each of which corresponds to each slide guide 306, are formed on an inner surface of the housing part 352. Further, a plurality of pressing part 354b, each of which corresponds to each coil spring 360, are formed on the inner surface of the housing part 352. The recess 354a is formed as a part of the housing part 352 and thereby made of resin. That is, the recess 354a (housing part 352) is made of resin material such as nylon 6 like that. Further, as shown in FIG. 6, a contact part 354c which is contactable with the slide guide 306 is formed at the rear end of the recess 354a. Further, a contact part 359a which is contactable with the front end of the gear housing 305 is formed on the front end part of the side handle mounting part 356.

As shown in FIG. 5 to FIG. 7, the handle rear part 350 is moved with respect to the main housing 301 from the rearward of the main housing 301 and the handle front part 355 is moved with respect to the main housing 301 from the frontward of the main housing 301, and thereafter by engaging the engagement protrusions 353 and the engagement recesses 358, the handle rear part 350 and the handle front part 355 are connected. Thereby, the hand grip 309 is assembled outside the main housing 301. That is, the hand grip 309 is assembled such that the housing part 352 covers the motor housing 303 and the extending part 357 extends along the gear housing 305. Accordingly, the housing part 352 is arranged outside the motor housing 303 such that each recess 354a engages with each slide guide 306 and each pressing part 354b presses each coil spring 360. With such a construction, one end of the coil spring 360 contacts with the motor housing 303 and another end of the coil spring 360 contacts with the pressing part 354b and thereby the coil spring 360 is held so as to bias the handle rear part 350. The handle rear part 350 is biased rearward by the coil springs 360, and at this time the contact part 359a of the handle front part 355 contacts with the front end of the gear housing 305. Thus, the hand grip 309 is prevented from moving rearward. The coil spring 360 is one example which corresponds to “a biasing member” of this disclosure. The housing part 352 is one example which corresponds to “an outer housing” of this disclosure.

A bellows member 308 is arranged between the gear housing 305 and the handle rear part 350. The bellows member 308 is expandable and contractible in the longitudinal direction of the hammer bit 119. Thus, relative movement of the hand grip 309 with respect to the gear housing 305 in the longitudinal direction of the hammer bit 119 is allowed. The bellows member 308 serves as a sealing member which seals a gap between the main housing 301 and the hand grip 309.

In the third embodiment, similar to the first and second embodiment, the hammer drill 300 has the counterweight 190 which is driven by the swing member 125 and causes a pendulum motion around the support shaft 195 as a fulcrum. Further, similar to the first embodiment, the counterweight may be formed as the counterweight 196 shown in FIG. 3. The gravity center of the counterweight 190, 196 is located between the grip portion distal part 351A2 and the cylinder 129 in the vertical direction of the hammer drill 300. That is, the gravity center of the counterweight 190, 196 is set to correspond to the intermediate region of the grip portion 351 which is mainly held by a user.

In the hammer drill 300 described above, when the trigger 309a is pulled, the electric motor 110 is driven. Thus, the hammer drill 300 performs the hammering operation or the hammer-drill operation based on the selected driving mode by the mode switching dial 215. During the operation, vibration is generated on the main housing 301 mainly in the longitudinal direction of the hammer bit 119. As the hand grip 309 is relatively moved against the main housing 301, the hand grip 309 is moved in the longitudinal direction of the hammer bit 119 based on the vibration generated during the operation.

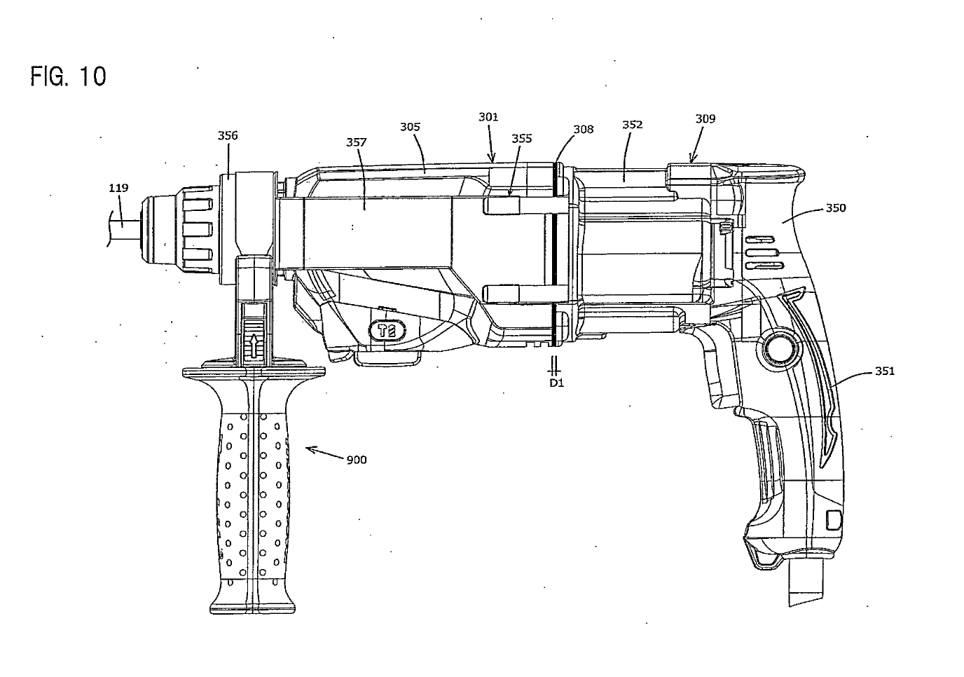

Specifically, as shown in FIG. 5 and FIG. 10, the main housing 301 and the hand grip 309 are moved in the longitudinal direction of the hammer bit 119 relatively to each other. FIG. 5 shows a rear position of the hand grip 309 which is positioned relatively rearward against the main housing 301. Further, FIG. 10 shows a front position of the hand grip 309 which is positioned relatively forward against the main housing 301.

As shown in FIG. 5, the hand grip 309 is positioned in the rear position by a rearward biasing force of the coil springs 360 (shown in FIG. 7 and FIG. 8) and a contact between the contact part 359a and the front end of the gear housing 305. In the rear position, a gap of distance D is provided between the gear housing 305 and the housing part 352. That is, the bellows member 308 is held in length D between the gear housing 305 (main housing 301) and the housing part 352 (hand grip 309). In this case, the side handle 900 mounted to the side handle mounting part 356 which is a part of the hand grip 309 is also positioned in its rear position together with the hand grip 309.

On the other hand, as shown in FIG. 10, the hand grip 309 is positioned in the front position against the biasing force of the coil springs 360. In the front position, the contact part 354c contacts with the rear end of the slide guide 306 and thereby the housing part 352 is held in a gap of distance D1 from the gear housing 305 (main housing 301). The distance D1 is shorter than the distance D. That is, the bellows member 308 is held in length D1 between the gear housing 305 (main housing 301) and the housing part 352 (hand grip 309). In this case, the side handle 900 is also positioned in its front position together with the hand grip 309.

The slide guides 306 and the recesses 354a are formed so as to extend parallel to the longitudinal direction of the hammer bit 119. Accordingly, by engagement between the slide guides 306 of the motor housing 303 and the recesses 354a of the handle rear part 305, a moving direction of the hand grip 309 between the front position and the rear position is set to be parallel to the longitudinal direction of the hammer bit 119. In this case, as the side handle mounting part 356 is formed a part of the hand grip 309, a moving direction of the side handle mounting part 356 along the gear housing 305 is set to be parallel to the longitudinal direction of the hammer bit 119.

The hand grip 309 is moved in the longitudinal direction of the hammer bit 119 against the main housing 301 (gear housing 305) via the coil springs 360 and thereby vibration transmission from the main housing 301 to the hand grip 309 is prevented by the coil springs 360. That is, the kinetic energy of the vibration is consumed by deformation of the coil springs 360 and thereby vibration transmission to the hand grip 309 is prevented.

Furthermore, similar to the first embodiment, the counterweight 190, 196 of the hammer drill 300 reduces the mainly longitudinal vibration generated on the main housing 301. That is, the hammer drill 300 has a first vibration proof mechanism in the form of the vibration proof handle in which the hand grip 309 is relatively moved against the main housing 301, and a second vibration proof mechanism in the form of the counterweight 190, 196. Accordingly, vibration transmission to a user holding the grip portion 351 of the hand grip 309 is prevented. As a result, a usability of the hammer drill 300 is improved.

### Fourth Embodiment

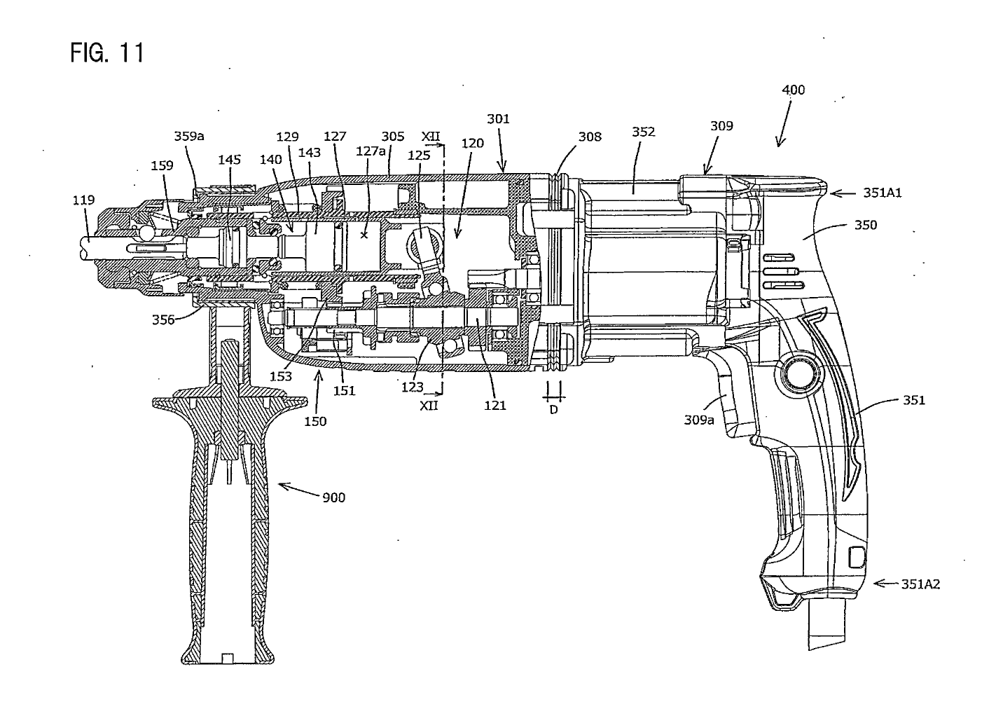

Next, a fourth embodiment of this disclosure is explained with reference to FIG. 11 to FIG. 15. A hammer drill 400 of the fourth embodiment has a dynamic vibration reducer as a mainly difference construction from other embodiments. Accordingly, similar constructions that are the same as those in the first to third embodiments have been assigned the same reference numbers and explanation thereof is therefore omitted.

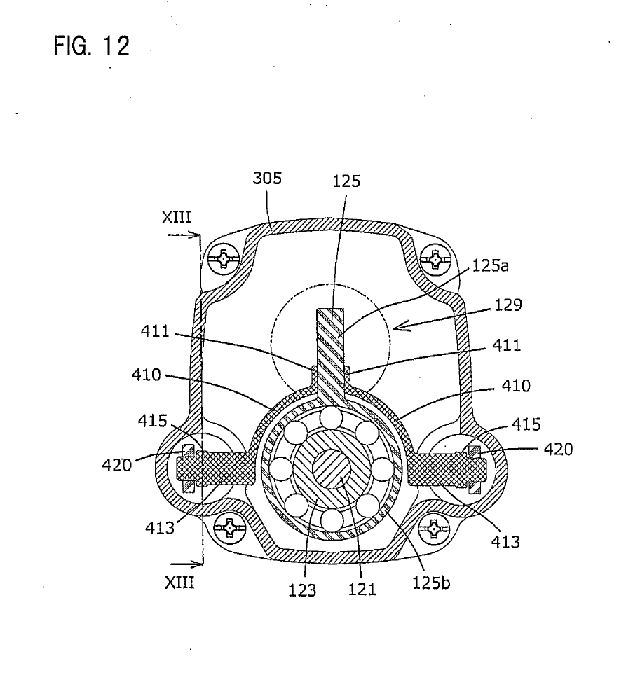

As shown in FIG. 11 to FIG. 13, the hammer drill 400 has dynamic vibration reducers 430 which are disposed right and left of the swing member 125, respectively, in a lateral direction (lateral direction in FIG. 12) crossing the longitudinal direction of the hammer bit 119 (front-rear direction of the hammer drill 400). The dynamic vibration reducers 430 are arranged below the upper edge of the cylinder 129 which holds the piston 127 in the vertical direction of the hammer drill 400. FIG. 12 shows a section of the hammer drill 400 in which the swing member 125 swung between a front position and a rear position in the longitudinal direction of the hammer bit 119 is located in a neutral position between the front position and the rear position. The dynamic vibration reducer is one example which corresponds to “a dynamic vibration reducer” of this disclosure.

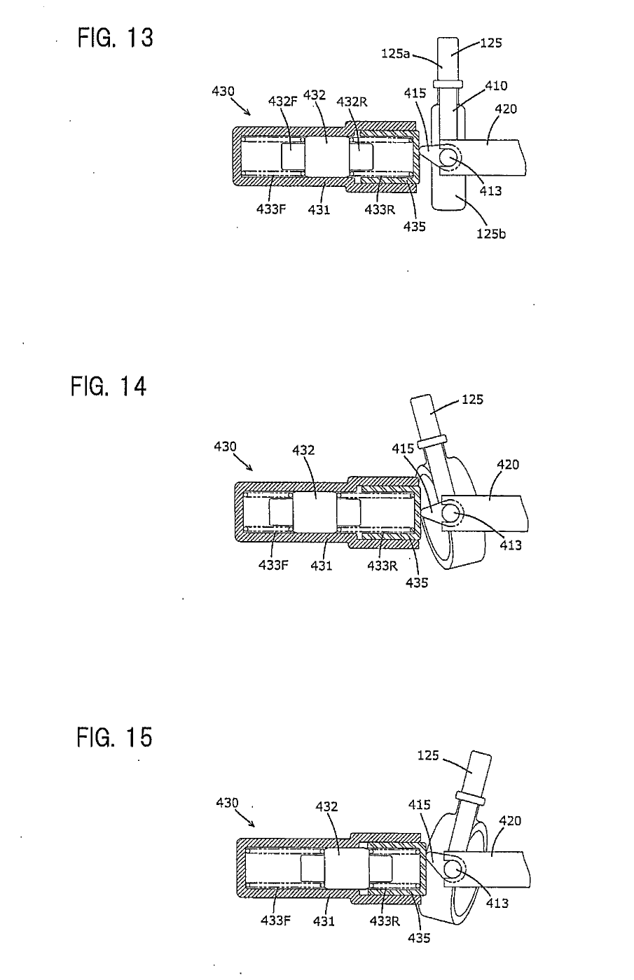

As shown in FIG. 12 and FIG. 13, a pair of driving arms 410 for driving the dynamic vibration reducers 430, respectively, are connected to the swing member 125. The driving arm 410 mainly includes a connection part 411 which is mounted to the swing member 125, an arm part 413 which is horizontally extended from the connection part 411 in the lateral direction of the hammer drill 400, and a contact part 415 which is contactable with the dynamic vibration reducer 430.

As shown in FIG. 12, the connection part 411 is connected to a shaft 125a of the swing member 125 in a rotatable manner around the shaft 125a. The arm part 413 is connected to the connection part 411. The arm part 413 extends in the lateral direction of the hammer drill 400 at an area which corresponds to a rotation center of a rotatable part 125a of the swing member 125 in the vertical direction of the hammer drill 400. Further, as shown in FIG. 12 and FIG. 13, the contact part 415 which extends from the arm part 413 toward the hammer bit 119 side (extends forward) is disposed at the distal end of the arm part 413.

As shown in FIG. 12 and FIG. 13, the distal end of the arm part 413 engages with a support member 420. The support member 420 extends in the front-rear direction of the hammer drill 400 and contacts with a rear part of the arm part 413. The support member 420 is fixed to the gear housing 305. Thus, the support member 420 supports the contact part 415 in a rotatable manner.

As shown in FIG. 13, the dynamic vibration reducer 430 mainly includes a dynamic vibration reducer body 431, a weight 432, biasing springs 433F, 433R, and a slide member 435. The dynamic vibration reducer body 431 is a hollow cylindrical member and is fixed to the gear housing 305. The weight 432 is slidably disposed within the dynamic vibration reducer body 431. Two dynamic vibration reducers 430 are disposed at right and left sides of the cylinder 129. Accordingly, the gravity center of the weights 432 of the dynamic vibration reducers 430 is positioned between a right edge and a left edge of the cylinder 129 in the lateral direction of the hammer drill 400. The weight 432 is one example which corresponds to “a weight” of this disclosure.

A front spring receiver 432F is formed on the front surface of the weight 432, and a rear spring receiver 432R is formed on the rear surface of the weight 432. The biasing springs 433F, 433R which extend in the longitudinal direction of the hammer bit 119 are disposed in front and the rear of the weight 432, respectively. The biasing spring 433F is arranged such that the front end of the biasing spring 433F contacts with the dynamic vibration reducer body 431 and the rear end of the biasing spring 433F contacts with the front spring receiver 432F of the weight 432. The biasing spring 433R is arranged such that the front end of the biasing spring 433R contacts with the rear spring receiver 432R and the rear end of the biasing spring 433R contacts with the slide member 435. The slide member 435 is a bottomed cylindrical member and slidably arranged within the dynamic vibration reducer body 431 in the longitudinal direction of the hammer bit 119. Accordingly, the weight 432 is slidably held within the dynamic vibration reducer body 431 in a state that biasing force of the biasing springs 433F, 433R is applied on the weight 432. The biasing springs 433F, 433R are examples which correspond to “an elastic member” of this disclosure.

As shown in FIG. 13 to FIG. 1S, the contact part 415 of the driving arm 410 contacts with the rear end of the slide member 435 and thereby the driving arm 410 reciprocates the weight 432 in the longitudinal direction of the hammer bit 119 via the slide member 435. That is, by swing motion of the swing member 125, the tip end (front end) part of the contact part 415 supported by the support member 420 causes a circular arc motion. The tip end part of the contact part 415 contacts with the slide member 435. Thus, distance between the slide member 435 and the support member 420 is changed due to the circular arch motion of the tip end part of the contact part 415.

Specifically, when the swing member 125 is moved from a neutral position shown in FIG. 13 to a forward position in which the shaft 125a of the swing member 125 is positioned forward as shown in FIG. 14, the tip part of the contact part 415 moves forward and moves the slide member 435 to its front position. Thus, the weight 432 is moved forward via the biasing springs 433F, 433R. That is, when the piston 127 is moved forward by the swing member 125, the weight 432 is also moved forward.

Further, when the swing member 125 is moved from the neutral position shown in FIG. 13 to a rearward position in which the shaft 125a of the swing member 125 is positioned rearward as shown in FIG. 15, the tip part of the contact part 415 moves rearward. Thus, the weight 432 is moved rearward by biasing force of the biasing springs 433F, 433R. That is, when the piston 127 is moved rearward by the swing member 125, the weight 432 is also moved rearward.

In the hammer drill 400 described above, when the trigger 309a is pulled by a user, a controller (not shown) provides electric current to the electric motor 110 from outer power source and drives the electric motor 110. The controller, similar to the first embodiment, controls the electric motor 110 under substantially constant rotation speed state. Thus, the hammer drill 400 is driven and the predetermined operation is performed.

During the operation, vibration is generated on the main housing 301 mainly in the longitudinal direction of the hammer bit 119. With respect to the longitudinal vibration, the hand grip 309 is relatively moved against the main housing 301 and thereby, similar to the third embodiment, vibration transmission from the main housing 301 to the hand grip 309 is prevented.

Further, the weight 432 of the dynamic vibration reducer 430 is linearly reciprocated in the longitudinal direction of the hammer bit 119 by the swing motion of the swing member 125 during the operation. Accordingly, the dynamic vibration reducer 430 reduces vibration in the longitudinal direction generated on the main housing 301.

As described above, the hammer drill has a first vibration proof mechanism in the form of the vibration proof handle in which the hand grip 309 is relatively moved against the main housing 301, and a second vibration proof mechanism in the form of the dynamic vibration reducer 430. Accordingly, vibration transmission to a user holding the grip portion 351 of the hand grip 309 is prevented. As a result, a usability of the hammer drill 400 is improved. Further, by relationship between the gravity center of the weights 432 of the dynamic vibration reducer 430 and the position of the grip portion 351, similar to the first embodiment, a usability of the hammer drill 400 is improved.

According to the embodiments described above, in the hammer drill which comprises the grip portion extending downward from the main housing, the gravity center of the weight is set to be positioned below the upper edge of the cylinder 129 which is one component of the driving mechanism. Thus, large moment due to the linearly reciprocating motion of the weight for preventing vibration on the main housing is prevented from acting on a user's hand holding the grip portion

In the embodiments described above, the main housing 101, 201, 301 houses the electric motor 110, the motion converting mechanism 120, the hammering mechanism 140 and the rotation transmitting mechanism 150, however, it is not limited to such a construction. For example, the electric motor 110 may not be housed by the main housing 101, 201, 301 but the hand grip 109, 209, 309.

Further, in the first and second embodiments, the battery mounting part 160 to which the battery pack 161 is detachably attached is provided, however, instead of the battery mounting part 160, a dust collection device mounting part to which a dust collection device is detachably attached may be provided. Further, in the first to fourth embodiments, a dust collection device mounting part may be provided on the main housing 101, 201, 301.

Having regard to an aspect of the invention, following feature is provided.

### (Feature 1)

An impact tool which drives a tool bit in a longitudinal direction of the tool bit and performs a predetermined operation, comprising:

a motor which includes a motor shaft,

a driving mechanism which is driven by the motor and drives the tool bit,

a main housing which houses the driving mechanism,

a handle which includes a grip portion extending in a cross direction crossing the longitudinal direction of the tool bit, the handle being configured to be moved with respect to the main housing,

a biasing member which is arranged between the main housing and the handle and applies biasing force on the handle, and

a weight which is housed in the main housing and movable with respect to the main housing,

wherein the weight is configured to reduce vibration generated on the main housing during the operation by relatively moving with respect to the main housing,

the handle is configured to prevent vibration transmission from the main housing to the handle during the operation by relatively moving with respect to the main housing in a state that the biasing force of the biasing member is applied on the handle,

the grip portion includes a proximal end part which is close to an axial line of the tool bit in the crossing direction and a distal end part which is remote from the axial line of the tool bit in the crossing direction, and

the weight is arranged such that the gravity center of the weight is positioned between the axial line of the tool bit and the distal end part of the grip portion.

The correspondence relationships between components of the embodiments and claimed inventions are as follows. The embodiments describe merely examples of configurations for carrying out the claimed inventions. However the claimed inventions are not limited to the configurations of the embodiments.

The hammer drill 100, 200, 300, 400 is one example of a configuration that corresponds to “an impact tool” of the invention.

The main housing 101, 201, 301 is one example of a configuration that corresponds to “a main housing” of the invention.

The outer housing 105 is one example of a configuration that corresponds to “an outer housing” of the invention.

The hand grip 109, 209, 309 is one example of a configuration that corresponds to “a handle” of the invention.

The electric motor 110 is one example of a configuration that corresponds to “a motor” of the invention.

The motor shaft 111 is one example of a configuration that corresponds to “a motor shaft” of the invention.

The compression coil spring 171 is one example of a configuration that corresponds to “a biasing member” of the invention.

The ring rubber 210, 211 is one example of a configuration that corresponds to “a biasing member” of the invention.

The coil spring 360 is one example of a configuration that corresponds to “a biasing member” of the invention.

The counterweight 190, 196 is one example of a configuration that corresponds to “a weight” of the invention.

The weight 432 is one example of a configuration that corresponds to “a weight” of the invention.

The weight part 192 is one example of a configuration that corresponds to “a first weight part” of the invention.

The weight part 192 is one example of a configuration that corresponds to “a second weight part” of the invention.

The weight 432 is one example of a configuration that corresponds to “a first weight part” of the invention.

The weight 432 is one example of a configuration that corresponds to “a second weight part” of the invention.

The motion converting mechanism 120 is one example of a configuration that corresponds to “a driving mechanism” of the invention.

The motion converting mechanism 120 is one example of a configuration that corresponds to “a motion converting mechanism” of the invention.

The hammering mechanism 140 is one example of a configuration that corresponds to “a driving mechanism” of the invention.

The hammering mechanism 140 is one example of a configuration that corresponds to “a hammering mechanism” of the invention.

The cylinder 129 is one example of a configuration that corresponds to “a cylinder member” of the invention.

The dynamic vibration reducer 430 is one example of a configuration that corresponds to “a dynamic vibration reducer” of the invention.

The biasing spring 433F, 433R is one example of a configuration that corresponds to “an elastic member” of the invention.

The battery mounting part 160 is one example of a configuration that corresponds to “a battery mounting part” of the invention.

### DESCRIPTION OF NUMERALS

100 hammer drill
101 main housing
103 motor housing
103A upper connection part
103B lower connection part
103C intermediate wall part
105 gear housing
109 hand grip
109a trigger
109A grip portion
109A1 grip portion proximal part
109A2 grip portion distal part
109B upper arm part
109C lower arm part
109D stay
110 electric motor
111 motor shaft
119 hammer bit
120 motion converting mechanism
121 intermediate shaft
123 rotating element
125 swing member
126 protrusion
127 piston
129 cylinder
140 hammering mechanism
143 striker
145 impact bolt
150 rotation transmitting mechanism
151 first gear
153 second gear
159 tool holder
159a bit insertion hole
160 battery mounting part
161 battery pack
171 compression coil spring
173 spring receiver
175 spring receiver
177 stopper pin
179 transverse hole
181 support shaft
190 counterweight
191 arm part
192 weight part
193 engagement hole
195 support shaft
196 counterweight
197 first circular arc part
198 second circular arc part
199 controller
200 hammer drill
201 main housing
203 motor housing
205 gear housing
206 outer housing
207 rubber receiving flange
208 rubber receiving flange
209 hand grip
209a trigger
209A grip portion
209A1 grip portion proximal part
209A2 grip portion distal part
209B upper connection part
209C lower connection part
210 ring rubber
211 ring rubber
215 mode switching dial
300 hammer drill
301 main housing
303 motor housing
305 gear housing
306 slide guide
308 bellows member
309 hand grip
309a trigger
350 handle rear part
351 grip portion
351A1 grip portion proximal part
351A2 grip portion distal part
352 housing part
353 engagement protrusion
354a recess
354b pressing part
354c contact part
355 handle front part
356 side handle mounting part
357 extending part
358 engagement recess
359a contact part
360 coil spring
400 hammer drill
410 driving arm
411 connection part
413 arm part
415 contact part
420 support member
430 dynamic vibration reducer
431 dynamic vibration reducer body
432 weight
432F front spring receiver
432R rear spring receiver
433F biasing spring
433R biasing spring
435 slide member
900 side handle

1. An impact tool which drives a tool bit in a longitudinal direction of the tool bit and performs a predetermined operation, comprising:
a motor which includes a motor shaft,
a driving mechanism which is driven by the motor and drives the tool bit,
a main housing which houses the driving mechanism,
a handle which includes a grip portion extending in a cross direction crossing the longitudinal direction of the tool bit, the handle being configured to be moved with respect to the main housing,
a biasing member which is arranged between the main housing and the handle and applies biasing force on the handle, and
a weight which is housed in the main housing and movable with respect to the main housing,
wherein the driving mechanism comprises a motion converting mechanism which converts rotation of the motor shaft into a linear motion in the longitudinal direction of the tool bit, and a hammering mechanism which includes a bottomed cylinder member, a driving element slidably housed within the cylinder member and a hammering element driven by the driving element and hammering the tool bit, the cylinder member being configured to be driven linearly by the motion converting mechanism and arranged coaxially with the tool bit,
the weight is configured to reduce vibration generated on the main housing during the operation by relatively moving with respect to the main housing,
the handle is configured to prevent vibration transmission from the main housing to the handle during the operation by relatively moving with respect to the main housing in a state that the biasing force of the biasing member is applied on the handle,
the grip portion includes a proximal end part which is close to an axial line of the tool bit in the crossing direction and a distal end part which is remote from the axial line of the tool bit in the crossing direction, and
the weight is arranged such that the gravity center of the weight is positioned on a distal end part side with respect to an edge of the cylinder member, the edge being is most distant from the distal end part of the grip portion in the crossing direction.

2. The impact tool according to claim 1, wherein the weight is arranged such that the gravity center of the weight is positioned between the edge of the cylinder member and the distal end part of the grip portion in the crossing direction.

3. The impact tool according to claim 1, wherein the weight is configured to be driven and moved forcibly against the main housing by the motor.

4. The impact tool according to claim 1, wherein the motion converting mechanism comprises a swing member which converts rotation of the motor shaft into a linear motion, and the weight is connected to the swing member.

5. The impact tool according to claim 4, wherein the swing member is configured to swing in the longitudinal direction of the tool bit on a plane which includes the axial line of the tool bit and an axial line of the grip portion, and
the weight comprises a first weight part disposed one side of the swing member with respect to the plane and a second weight part disposed another side of the swing member with respect to the plane.

6. The impact tool according to claim 4, comprising a support part which supports the weight,
wherein the weight is driven by the swing member and causes a pendulum motion around the support part as a fulcrum.

7. The impact tool according to claim 1, comprising an elastic member which elastically biases the weight,
wherein the weight and the elastic member serve as a dynamic vibration reducer in which the weight is relatively moved against the main housing in a state that the elastic member biases the weight.

8. The impact tool according to claim 1, comprising an outer housing which covers at least apart of a region of the main housing which covers the driving mechanism and the motor,
wherein the handle is connected to the outer housing and integrally moved with the outer housing with respect to the main housing.

9. The impact tool according to claim 8, comprising an auxiliary handle attachable part to which an auxiliary handle is detachably attached,
wherein the auxiliary handle attachable part is connected to the outer housing and integrally moved with the handle connected to the outer housing with respect to the main housing.

10. The impact tool according to claim 1, comprising a controller which controls rotation speed of the motor to be driven at substantially constant rotation speed.

11. The impact tool according to claim 1, wherein the motor is provided as a brushless motor.

12. The impact tool according to claim 1, wherein the motor is arranged such that the motor shaft is parallel to the axial line of the tool bit.

13. The impact tool according to claim 1, wherein the grip portion is disposed on an extending line of the axial line of the tool bit.

14. The impact tool according to claim 1, wherein a battery mounting part to which a battery is detachably mounted is formed on the distal end part of the grip portion.

15. The impact tool according to claim 1, comprising a dust collecting device mounting part to which a dust collecting device for collecting dust during the operation is detachably mounted.
